(19) United States
(12) Patent Application Publication
(10) Pub. No.: US 2005/0198401 A1
(43) Pub. Date: Sep. 8, 2005

(54) Efficiently virtualizing multiple network attached stores

(76) Inventors: Edward Gustav Chron, Sunnyvale, CA (US); Paul Morgan, San Jose, CA (US); Lance W. Russell, Hollister, CA (US)

Correspondence Address: FREDERICK W. GIBB, III;MCGINN & GIBB, PLLC, 2568-A RIVA ROAD, SUITE 304, ANNAPOLIS, MD, 21401, US

(21) Appl. No.: 10/767,593

(22) Filed: Jan. 29, 2004

(51) Int. Cl. G06F 15/16

(52) U.S. Cl. 709/250; 709/217

(57) ABSTRACT

A method and structure for communicating in a communications network comprising at least one communication virtualizer; a plurality of network-attached store computers connected to the communication virtualizer, wherein the plurality of network-attached store computers are configured to appear as a single available network-attached store computer; and at least one client computer connected to the communication virtualizer.

### BACKGROUND OF THE INVENTION

1. Field of the Invention

The invention generally relates to communication networks, and more particularly to a system of networks for servicing requests for storage sent by client computers over a communications network.

2. Description of the Related Art

Conventionally to balance network-attached stores (NAS) load, dedicated NAS servers are tuned to provide good NAS performance. However, when clients connect with transmission control protocol (TCP) their session is dedicated to the NAS server they are connected to. Assuming the vendor provides a solution where more than one NAS server can handle requests the typical method used to load balance between servers is to move a TCP session from one server to another. Moving the entire session is expensive, slow and often requires kernel modifications to facilitate a seamless move. This approach has the significant limitation that the entire session moves from one server to another, meaning the load balancing capability is very coarse.

Therefore, there remains a need for a system and method that virtualizes a plurality of network-attached stores working together to make the plurality of stores appear as if they are one large and highly available store.

### SUMMARY OF THE INVENTION

In view of the foregoing, an embodiment of the invention provides a communications network comprising at least one client computer, an external communication network, at least one communication virtualizer, an internal communication network, and a plurality of network-attached store (NAS) computers. The communications network further comprises means for computers to send and receive information to each other, and a protocol whereby the information may be meaningfully exchanged.

The communications network may comprise Ethernet links and the Transmission Control Protocol/Internet Protocol (TCP/IP) suite of protocols for computer-to-computer communication, and the Network File System (NFS) protocol as a storage access protocol, enabling client computers to request access to storage from NAS computers. A network-attached store computer comprises a server computer that accepts processes and responds to client computer requests for accessing storage.

One or more network switches attach to and connect the internal and external communication networks, allowing a client computer to send a request to a NAS computer, and the NAS computer to send a reply to the client computer. A communications virtualizer comprises means for: receiving a request from a client, choosing a NAS computer that can process the request, and routing the request to the NAS computer; receiving a response from the NAS computer, determining the client to which the response should be sent, and routing the response to the client.

A client computer sending a request to access storage addresses the request to the communication virtualizer and receives a response from the virtualizer. The client computer need not be aware that the request is routed to a NAS computer for processing, or indeed, that there is a plurality of NAS computers comprised in the system. The selection of a NAS computer to process and respond to the client request is masked from the client computer by the virtualizer.

In one embodiment, the communication virtualizer is incorporated into the network switch. In another embodiment, the communication virtualizer is incorporated into each of the NAS computers, for example as a software extension to the communications layer of the NAS computer operating system.

In another embodiment, the invention provides a method of communication over a communications network, wherein the method comprises sending requests for storage originated by at least one client computer over the communications network, receiving the requests for storage in at least one communication virtualizer, and transmitting the received requests for storage to a plurality of network-attached store computers connected to the communication virtualizer(s), wherein the plurality of network-attached store computers are configured to appear as a single available network-attached store computer, wherein the communication virtualizer(s) upon receiving requests from the client computers, transmit the request for storage to a chosen network-attached store computer based on a capability of the chosen network-attached store computer to properly process the request for storage, wherein the requests for storage are transmitted as a series of packets, each packet comprising a portion of the request for storage, and wherein each packet comprises a packet sequence number, wherein the packets comprising a single request for storage are linked together using a request identifier and the packet sequence number, and wherein each request for storage comprises a unique request identifier that is shared among the packets comprising the single request.

Additionally, the network-attached store computer is configured for receiving the requests for storage from the communication virtualizer(s), processing the request for storage; creating a corresponding response to the request for storage, packetizing the corresponding response, and sending the corresponding response to the communication virtualizer(s). Furthermore, the communication virtualizer(s) are configured for receiving the corresponding response from the network-attached store computer, determining whether the corresponding response comprises a single packet, determining a chosen client computer to which the corresponding response should be forwarded to, and forwarding the corresponding response to the chosen client computer. Moreover, the chosen client computer is configured for receiving the corresponding response from the communication virtualizer(s), de-packetizing the corresponding response if necessary, and forwarding the corresponding response to an initiating application.

Also, the packets are categorized from a zeroth (0th) packet to an ith packet, wherein the communication virtualizer(s) determine which network-attached store computer to transmit the request for storage to by examining the zeroth packet in the request. The method further comprises the client computer sending standard Ethernet packets to the communication virtualizer(s), and the communication virtualizer(s) combining multiple standard Ethernet packets for a request into a single large packet.

The invention also provides a system for facilitating communication between a client computer and a network-attached store computer, the system comprising means for sending requests for storage originated by at least one client computer over the communications network, means for receiving the requests for storage in at least one communication virtualizer, and means for transmitting the received requests for storage to a plurality of network-attached store computers connected to the communication virtualizer, wherein the plurality of network-attached store computers are configured to appear as a single available network-attached store computer.

The invention provides a novel system and method that virtualizes a plurality of stores working together, i.e., to make the plurality of stores appear as if they are one large and highly available store. The invention exhibits several advantages over existing virtualization methods. Among these are initial self-configuration, dynamic self-reconfiguration, dynamic load balancing support, the elimination of complex cluster protocols, efficient performance tracking, protocol translation flexibility, efficiency via protocol translation, efficiency via Medium Access Control (MAC) address swapping, and efficiency via multicast addressing.

In addition to these features a unique approach that is advantageous is to avoid having to install any software on the client systems. This is critical to customers as clients may number in the thousands; the cost of installing and maintaining software on each system can be prohibitive. The invention achieves this by allowing Network File System (NFS) or Common Internet File System (CIFS) access between clients and NAS computers with the communication virtualizer acting as the intermediary between the two, providing a virtual single interface for clients to access the resources of the NAS computers.

Moreover, the invention can load balance NFS exported filesystems and CIFS exported filesystems or any network file protocol simultaneously. Furthermore, the invention can act as a file switch and in fact the software code can be incorporated into a network switch/router but is not limited to running in a switch/router. Additionally, the invention can operate on the servers it load balances. Also, the invention can operate on commodity hardware (off the shelf computers) or customized hardware. Moreover, the invention has been tested to operate as extensions to a general purpose, embedded or real-time operating system (OS). The invention's flexibility in running (operating) on different types of hardware in conjunction with a variety of operating and supporting multiple file protocols give it a decided advantage over the less flexible conventional approaches.

In testing, the invention has been shown to analyze and load balance file requests and can do so at either the session or request level. Request-based load balancing provides a much richer form of load balancing versus session-based approaches as any request can be routed to any server. The need for a device with the features provided by the invention, such as an enabler that virtualizes and provides efficient access to multiple file-based stores in an autonomic fashion has been a demonstrable advantage in the industry.

These and other aspects and advantages of the invention will be better appreciated and understood when considered in conjunction with the following description and the accompanying drawings. It should be understood, however, that the following description, while indicating preferred embodiments of the invention and numerous specific details thereof, is given by way of illustration and not of limitation. Many changes and modifications may be made within the scope of the invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a system block diagram illustrating an indirect response path according to a preferred embodiment of the invention;

FIG. 2 is a system block diagram illustrating a direct response path according to a second embodiment of the invention;

FIG. 3 is a flow diagram illustrating a mainline request-response processing method according to a preferred embodiment of the invention;

FIG. 4 is a flow diagram illustrating a multi-packet request processing method according to an alternative embodiment of the invention;

FIG. 5 is a system block diagram illustrating a direct response path according to a third embodiment of the invention;

FIG. 6 is a system block diagram illustrating a fourth embodiment of the invention; and

FIG. 7 is a flow diagram illustrating a preferred method of the invention.

### DETAILED DESCRIPTION OF PREFERRED EMBODIMENTS OF THE INVENTION

The invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the invention. The examples used herein are intended merely to facilitate an understanding of ways in which the invention may be practiced and to further enable those of skill in the art to practice the invention. Accordingly, the examples should not be construed as limiting the scope of the invention.

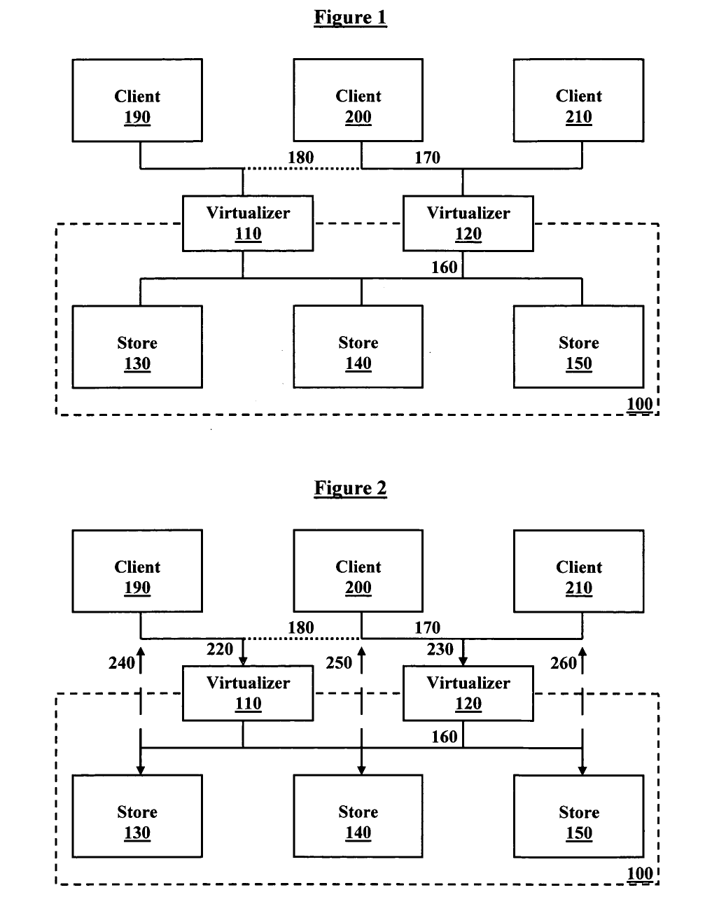

As previously mentioned, there is a need for a system and method that virtualizes a plurality of network-attached stores working together to make the plurality of stores appear as if they are one large and highly available store. Referring now to the drawings, and more particularly to FIGS. 1 through 7, there are shown preferred embodiments of the invention.

As depicted in FIG. 1, in a preferred embodiment the invention provides a system 100 comprising one or more virtualizers 110, 120, a plurality of stores 130, 140, 150, and an internal network 160 connecting the virtualizers 110, 120 to the stores 130, 140, 150. Connected to the system is an external network 170, including potentially one or more distinguished segments 180, and one or more clients 190, 200, 210, respectively.

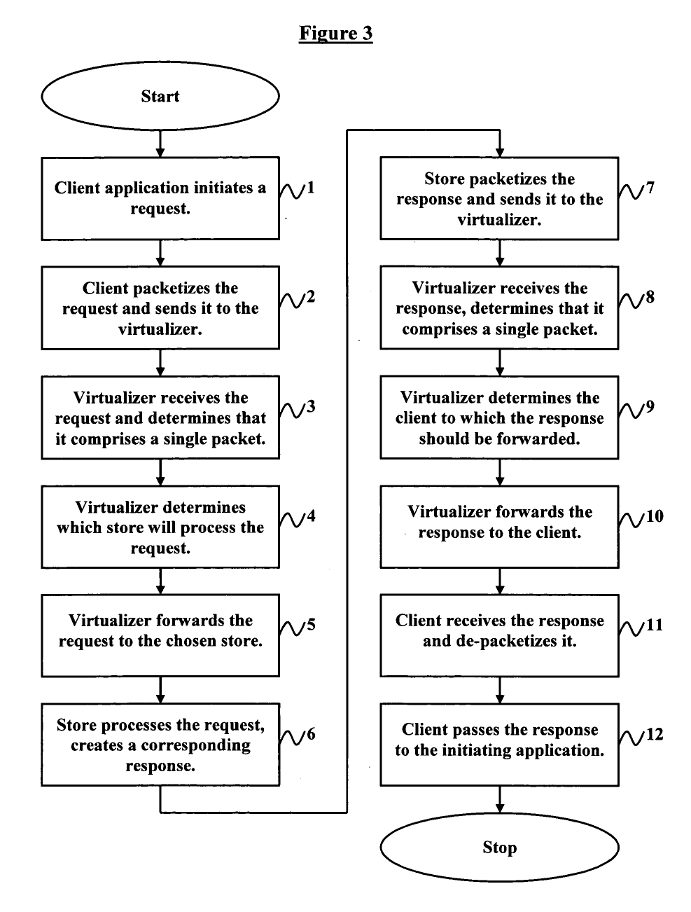

As illustrated in FIG. 2, in a second preferred embodiment, the clients send requests to the virtualizers 110, 120 via the external network connections 220, 230, and the stores 130, 140, 150 send responses to the clients 190, 200, 210 via external network connection paths 240, 250, 260, bypassing the virtualizers 110, 120. In this embodiment, enhanced performance may be achieved, as the virtualizers 110, 120 need not process the responses.

In the preferred embodiment, the communications network comprises an Ethernet networking hardware and medium access protocol. The client-to-store networking protocols are those encompassed by the Transmission Control Protocol/Internet Protocol suite of protocols. Moreover, the storage access protocol comprises a Network File System protocol. A client, e.g., 190, sends a request to the system by addressing the request to a virtualizer, e.g., 110, as though it were a network router. That is, the client 190 has a table in its memory comprising entries of the form, “to reach the system 100, requests must be sent to the virtualizer 110.” It is understood that, in a well-formed network, a router, in this case the virtualizer 110, will forward requests sent to it, to the next node in some path destined to reach the end-point, in this case the system 100.

The virtualizer 110, 120, upon receiving a request destined for the system 100, determines which store(s). 130, 140, 150 are capable of processing the request, chooses a store from among these, and forwards the request to the chosen store, e.g., store 130. The store processes the request and upon completion of processing, may return a response to the client, e.g., 190, that sent the request. The store 130 addresses the response to the client 190, but sends it to the virtualizer, e.g., 110. The virtualizer 110, upon receiving the response, forwards it to the client 190.

In a preferred embodiment, each request has exactly one corresponding response and the store 130 returns the response to the virtualizer 110 that forwarded the request to the store 130. In a preferred embodiment, a request (or response) beyond a certain length (number of octets, or eight-bit bytes) is transmitted as a series of packets, each of which comprises a part of the request. Packets comprising a given request are linked together logically by virtue of a request identifier, and a packet sequence number. Each request has a unique request identifier that is shared among the packets comprising the request and no others. Each packet comprising a request has a packet sequence number unique to the packet within the request. In general, the ith packet within a request has sequence number i; in particular, the 0th (or zeroth) has sequence number 0. In addition, the last packet in a request is marked as such with an end-of-request flag. If (and only if) the flag is set, the packet is the last of the request.

The invention exhibits several advantages over existing virtualization methods. Among these advantages are initial self-configuration, dynamic self-reconfiguration, support for dynamic load balancing, no need for complex cluster protocols, efficient performance tracking, flexibility via protocol translation, efficiency via protocol translation, efficiency via Medium Access Control (MAC) address swapping, and efficiency via multicast addressing.

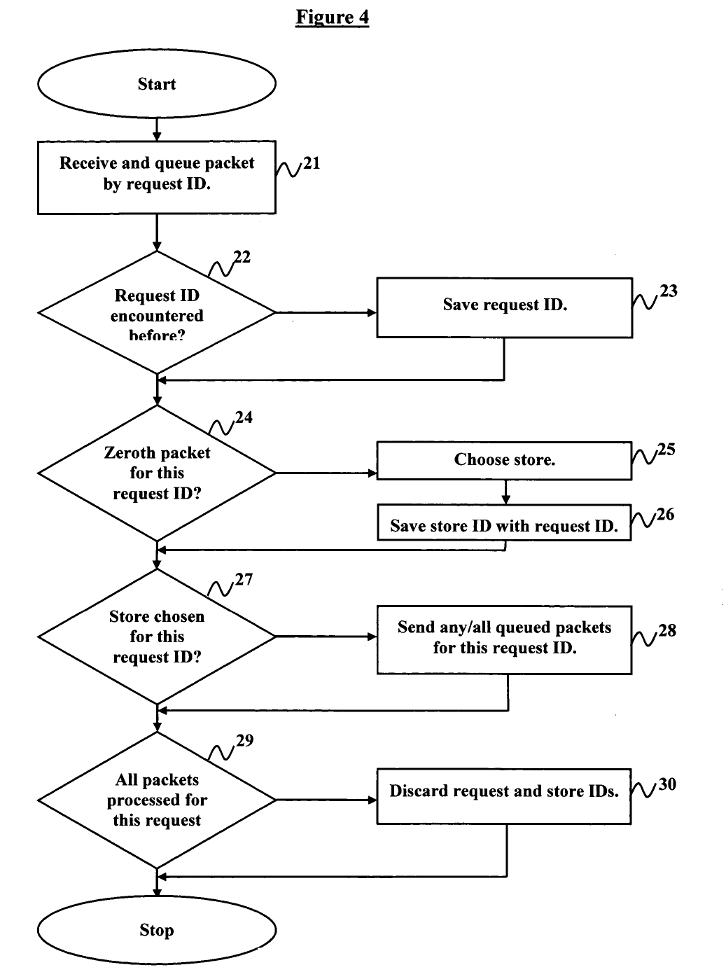

Single-packet request-response processing is depicted in the flowchart of FIG. 3 (illustrated generally as steps 1-12). An example of such a request would be to create a file within a given directory. A virtualizer 110, 120 receives a request. The virtualizer 110, 120 determines that the request comprises a single packet because the packet sequence number is zero and the end-of-request flag is set. The virtualizer 110, 120 determines which store will process the request, and forwards the request to the corresponding store 130, 140, 150.

The store 130, 140, 150 receives the request packet and processes it. Next, the store 130, 140, 150 constructs a response, typically including an indication whether the request was processed correctly, and any data to be returned with the response. The store 130, 140, 150 addresses the response to the client 190, 200, 210, but sends it to the virtualizer 110, 120, which acts as a network router to the client 190, 200, 210. In the simple case, the response comprises a single packet, although a response may comprise multiple packets. Upon receiving a single-packet response, the virtualizer 110, 120 forwards it to the client 190, 200, 210.

All packets comprising a multiple-packet request must be delivered to the same store 130, 140, 150. The client 190, 200, 210 sending a request may send the packets out of order, or they may be re-ordered in transmission. A virtualizer 110, 120, upon receiving a request with a request identifier different from any it has encountered before, tracks the packets comprising the request. The virtualizer 110, 120 queues packets until it has determined the store 130, 140, 150 to which the request is to be forwarded. Once the store 130, 140, 150 has been chosen, the virtualizer 110, 120 forwards to the store 130, 140, 150 all of the packets comprising the request. The virtualizer 110, 120 tracks the request until it has forwarded to the store 130, 140, 150 all of the packets comprising the request.

In a preferred embodiment, the virtualizer 110, 120 determines the store 130, 140, 150 to which a request should be sent by examining the zeroth packet in a request. The differences between single- and multi-packet request processing procedures are limited to steps 3-5 of FIG. 3. The flowchart depicted in FIG. 4 illustrating steps 21-30, replaces those steps (only) for multi-packet request processing.

Similarly, a response may comprise multiple packets. In a preferred embodiment, each packet comprising a response identifies the client 190, 200, 210 to which the response should be delivered. Upon receiving a packet comprising a response, a virtualizer 110, 120 forwards the packet to the client 190, 200, 210. When processing a multiple packet response, steps 8-11 of FIG. 3 are followed, except that steps 8-10 are redirected to response packet processing (rather than response processing), and step 11 includes re-assembling the multiple response packets into a single response.

The virtualizer 110, 120 may, for various reasons, translate a communications protocol that a client 190, 200, 210 uses to access the virtual store 130, 140, 150, into another protocol within the system 100. Reasons include, but are not limited to, more efficient use of the stores 130, 140, 150, better load balancing, and support for protocols not natively supported by the stores 130, 140, 150.

In a preferred embodiment, a client 190, 200, 210 sends standard Ethernet packets, limited in length to 1,536 octets, to a virtualizer 110, 120. The virtualizer 110, 120 combines multiple standard Ethernet packets into one so-called “jumbo” packet that may comprise up to approximately 9,000 octets. As the maximum request or response size for a conventional NFS protocol (e.g., NFS Version 3) is smaller than the size of a jumbo packet, an entire NFS request or response may be incorporated into one jumbo packet, with the concomitant advantage that the request may be processed at one time by the store, reducing the number of interruptions the store must process, and potentially allowing the store to schedule its access to resources optimally.

In a preferred embodiment, the virtualizer 110, 120 may translate a connection-oriented client-to-store protocol into a datagram-oriented one. A client 190, 200, 210 may create a connection to a virtualizer 110, 120 as if it were connecting to the virtual store 130, 140, 150. Once the connection has been established, the client 190, 200, 210 may send a stream of requests to the virtualizer 110, 120. The virtualizer 110, 120, may select individual requests from the packet stream to act on. Next, the virtualizer 110, 120 may attempt to balance load among the stores 130, 140, 150 by sending the request to an appropriate store; e.g. 130. Also, the virtualizer 110, 120 may choose to send the request to a certain store; e.g. 130 for various other reasons.

In a second embodiment, a virtualizer 110, 120 may translate a first client-to-store NAS protocol into a second one, so that a client 190, 200, 210 may access the virtual store 130, 140, 150 using a protocol that is convenient for the client 190, 200, 210, but that may be inconvenient for a store 130, 140, 150. For example, a store 130, 140, 150 may support only the NFS protocol, but a client 190, 200, 210 may support only the Common Internet File System (CIFS) protocol. In this case, the virtualizer 110, 120 would translate incoming CIFS requests into NFS requests, and outgoing NFS responses into CIFS responses.

The virtualizer 110, 120 may decide which store 130, 140, 150 is to process a given request in any of various ways. An aspect of the invention is that the identification of the NAS stores is virtualized; i.e., external to the system 100, there appears to be a single actual store. A client 190, 200, 210 directs a request to a virtualizer 110, 120 as if the virtualizer 110, 120 was a network router, and the virtualizer 110, 120 “forwards” the request to the (virtual) store 130, 140, 150.

In a preferred embodiment, no store with the identification as seen to the client actually exists. In this preferred embodiment, multiple virtualizers, e.g., 110 and 120 of FIG. 1, may act as network routers to the same virtual store; e.g., 130. A client 190, 200, 210 accessing the virtual store 130, 140, 150 may do so via any virtualizer 110, 120 that the client 190, 200, 210 may reach via the network.

For example, in FIG. 1, client 200 may access the virtual store 130, 140, 150 via virtualizer 110, 120. In a well-configured and well-managed network, the client 200 would be directed automatically via an external network protocol such as Open Shortest Path First (OSPF) to one virtualizer 110, 120 or to another based on various criteria. For example, the client 200 may be directed to access the virtual store 130 via virtualizer 110, if the “cost” of reaching the virtual store 150 via virtualizer 120 were higher than that of virtualizer 110. This might happen if, for example, slow network links are deployed between the client 190 and virtualizer 120, or if network traffic is heavy between the client 190 and virtualizer 120.

On the other hand, if distinguished link 180 were to fail or become heavily overloaded or otherwise exhibit poor performance characteristics, client 200 may be directed; e.g., by a network routing protocol or by a human, to access the virtual store 130 via virtualizer 110. Of course, the virtualizers 110, 120 themselves may play a role in redirecting clients 190, 200, 210.

In a preferred embodiment, the OSPF protocol is used to reconfigure the network, and the virtualizers 110, 120 act as OSPF-participant routers. The virtualizers 110, 120 may participate independently in OSPF network reconfiguration, or they may share information and act in concert to balance the ratio of network traffic coming into each virtualizer 110, 120. Alternatively, network routing protocols other than OSPF may be used instead, including various exterior routing protocols such as Border Gateway Protocol.

In addition to using OSPF or other routing protocols for network load balancing, virtualizers 110, 120 may use such protocols to survive certain types of failures; e.g., the failure of one or more virtualizers 110, 120. Of course, to do so, at least one virtualizer; e.g., 110 must remain operable.

In a preferred embodiment, a first virtualizer; e.g., 110 recognizes when a second virtualizer; e.g., 120 enters service and when a second virtualizer 120 fails or otherwise is removed from service. When such an event occurs, the first virtualizer 110 reconfigures, in concert with other operational virtualizers 120. After reconfiguration, clients 190, 200, 210 may be redirected from one virtualizer 110 to another 120.

In a preferred embodiment, an Ethernet or a similar physical networking medium, such as a token ring is used, and network to physical layer address resolution is performed via a protocol such as the Address Resolution Protocol. In this embodiment, a well-known method such as Gratuitous ARP Address Takeover may be used to force clients attached to the same local segment of the network as the failed virtualizer 1 10 to switch to a different virtualizer 120.

The Gratuitous ARP method is especially useful when clients 190, 200, 210 do not treat the virtualizer 110, 120 as a network router, either because they are not capable of participating in routing protocol, or because it would make little sense for them to do so. The Gratuitous ARP method may be used to force clients 190, 200, 210 to switch back, after the failed virtualizer 1 10, 120 has been repaired or otherwise placed back into service.

In another embodiment, an Ethernet or a similar physical networking hardware such as token ring is used. However, in these embodiments, the Medium Access Control (MAC) address, rather than the packet's network address, of a packet directs the packet to its destination. The packet's network address field is ignored by the destination hardware.

In another embodiment, a checksum is used to detect whether a packet has been corrupted during transmission across a network. Often, the computation of the checksum is costly, in terms of hardware, software, or latency. Advantages would accrue if the virtualizer 110, 120 would not have to compute the checksum. When using the TCP/IP suite of protocols and Ethernet or similar physical networking hardware, a packet's MAC address is modified as the packet is routed through the network. However, its network address remains unchanged. To avoid re-computing the checksum at each intermediate node, Ethernet and similar link layer protocols do not include the MAC address in the checksum calculation. The Internet Protocol (network layer) address, by contrast, is included in the calculation.

In another embodiment, the internal network 160 is routerless, i.e., any virtualizer 110, 120 can forward a packet to any store without sending the packet through a network router. In this case, the virtualizer 110, 120 may swap the packet's incoming MAC address (that of the virtualizer's incoming network interface) with that of the store's interface on the internal network. In this way the virtualizer 110, 120 need not recompute the checksum. A virtualizer 110, 120 may gather performance information on a request-by-request basis, or it may do so using statistical sampling techniques.

As depicted in FIG. 4, the virtualizer 110, 120 maintains basic information about a request, i.e., the request identifier and the store 130, 140, 150 to which the request was sent, until the final packet of the request has been sent to the store 130, 140, 150, at which point the virtualizer 110, 120 discards the information.

To maintain performance information regarding a request, step 10 of FIG. 4, in which the request and store identifiers are discarded, is replaced by a new step. In the new step, a timestamp is created and is recorded along with the request identifier. The timestamp indicates the first time at which the request could have been processed. Other information, such as the type of request, identifiers for the storage objects upon which the request is to operate, and/or various other parameters, also may be recorded. A response must indicate in some way the request to which it corresponds. Alternatively, the client 190, 200, 210 sending the request could not have multiple requests outstanding at a given time.

In a preferred embodiment, at least one packet of the response includes the request identifier. In this embodiment, the virtualizer 110, 120, upon receiving the packet containing the request identifier, creates a timestamp for the response, and records it along with the request identifier, the timestamp of the request, and any other parameters that were recorded. This data may be retrieved later for various purposes, including performance analysis.

In a preferred embodiment, the virtualizer 110, 120 need not maintain information on every request it processes. This may be useful if only statistical performance information is needed. Moreover, this data may be summarized in various ways, and gathered periodically, for online or offline analysis. An advantage of the. system and method according to the invention is that they together support unmodified, industry-standard stores, with obvious advantages. To further this aim, the combination system and method may need to support automatic configuration and reconfiguration.

In a preferred embodiment, the virtualizer 110, 120 acts as a Dynamic Host Configuration Protocol (DHCP) server, assigning to a store an Internet Protocol (IP) address, one or more network router IP addresses (typically virtualizer IP addresses), one or more name server IP addresses (which may be those of virtualizers), and various other parameters, as necessary. As parameters, the virtualizer 110, 120 may identify a boot program server and operating program image name that a store 130, 140, 150 combines to locate and load its initial program. In this way, the virtualizer 110, 120 may automatically configure the store's software, without modifying the store 130, 140, 150.

In a preferred embodiment, certain configuration information is set manually. This includes a list of storage that may be accessed by clients 190, 200, 210. The list may be trivial; e.g., every client 190, 200, 210 may access all storage. Alternatively, the list may be more restrictive; e.g., only certain clients (e.g., client 190 only) may access certain storage and/or only certain stores (e.g., store 130 only) may serve certain storage. Additionally, the system 100 may act as if it comprises multiple NAS stores 130, 140, 150, rather than only one 130, either in combination with the prior embodiments, or separately from them. These configuration parameters may be stored in a manner directly accessible to a virtualizer 110, 120, or a virtualizer 110, 120 may determine them in combination with other virtualizers 110, 120 and/or stores 130, 140, 150.

The virtualizer 110, 120 may determine configuration information in combination with stores 130, 140, 150 in any of various ways. For example, a store 130, 140, 150 typically makes such information available via industry-standard protocols. For example, the NFS remote mount protocol allows the virtualizer 110, 120 to query the storage that a store 130, 140, 150 “exports” for access by its clients 190, 200, 210, as well as limitations on access by the clients 190, 200, 210.

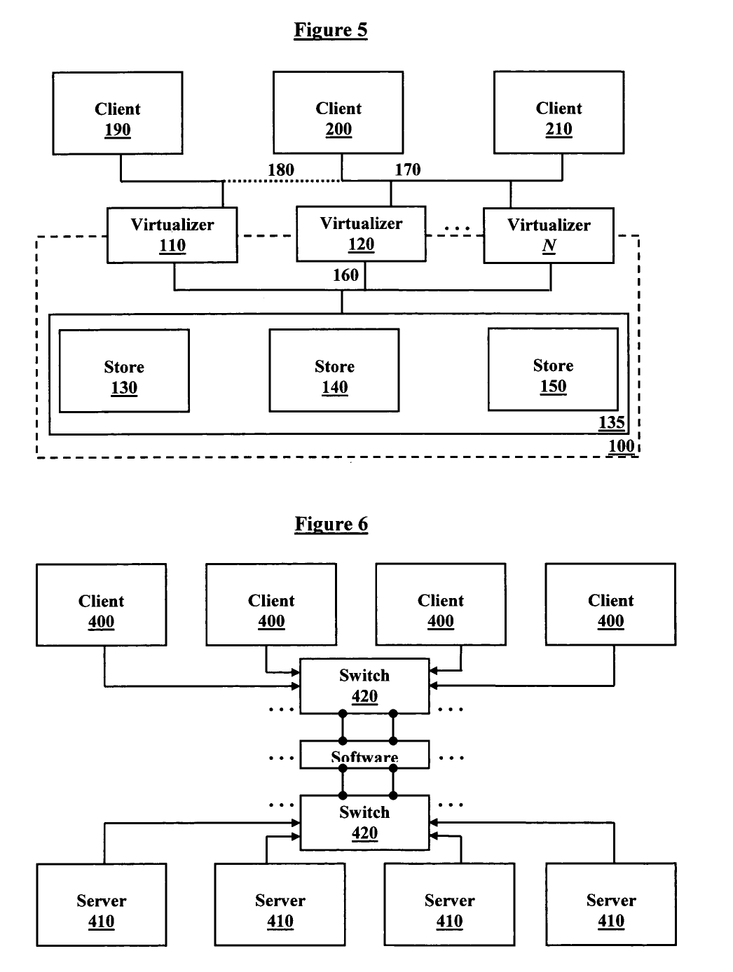

In another example, the Simple Network Management Protocol (SNMP) allows the virtualizer 110, 120 to determine the IP and MAC addresses assigned to a store's network interfaces. If a suitable convention is followed, the virtualizer 110, 120 may infer the virtual IP addresses to be supported by a store 130, 140, 150, and therefore the set of stores 130, 140, 150 that are to act as one large virtual store 135, as shown in FIG. 5. For example, the physical network interfaces of the stores 130, 140, 150 (connected to the internal network 160) may be configured with two or more IP addresses. A first address may be private IP addresses; e.g., 192.168.nnn.nnn, while a second, third, and so forth address may be in any other range. The virtualizer 110, 120 may infer that the second, third, and so forth addresses correspond to virtual IP addresses.

In a preferred embodiment involving a plurality of virtualizers 110, 120, the virtualizers 110, 120 may need to share configuration information among them to determine an optimal overall system configuration. Various well-known procedures have been described in the literature for sharing information and making optimal configuration decisions. However, the method described below, which is particular to the invention, may be employed for high efficiency, high scalability, rapid detection of configuration changes, and rapid reconfiguration.

The method is based on a periodic multicast among the multiplicity of virtualizers 110, 120 on the internal network 160. In a simple implementation, each virtualizer 110, 120 periodically multicasts to all other virtualizers 120, 110, respectively, its “view” of the system's configuration. Upon receipt of such information from a first virtualizer 110, each other virtualizer 120 updates its configuration to match this information. Potential conflicts may be resolved via a loose configuration protocol as described below, if necessary.

Although relatively efficient, the simple implementation is sub-optimal for highly scalable systems as, for each period, a virtualizer 110 receives one multicast from every other virtualizer 120. In a slightly more complex implementation illustrated in FIG. 5, involving large numbers of virtualizers 110, 120, . . . , N, the virtualizers 110, 120, . . . , N may multicast in round-robin order, rather than once per period. That is, virtualizers are numbered 0 through N−1; in period 0, virtualizer 0 multicasts; in period 1, virtualizer 1 multicasts; and so forth. If period i is reached without virtualizer i having received a multicast from virtualizer i−1, virtualizer i may suspect that virtualizer i−1 no longer is operational, and may initiate a loose configuration protocol.

System configuration occurs via an efficient loose configuration protocol in which system configuration of both the stores 130, 140, 150 and the virtualizers 110, 120, is tracked without explicit synchronization. This protocol is more efficient than commonly used group membership protocols because of the overhead required by full group membership, including multiple rounds of messages, synchronization and voting are not used. A component's view of the system's configuration may be out of date; nevertheless, the system 100 will operate correctly. This is so because NAS protocols rely on client-side retry for recovery, if a request is dropped or lost by the communications network.

If a system component has an out-of-date view of the system configuration, the request may be misdirected or lost, or a reply may be lost. In any case, if after a brief delay (e.g., a few seconds or minutes), the client 190, 200, 210 that sent the request did not receive a response, the client 190, 200, 210 will retry the request. Eventually, the component will have an up-to-date view of the system's configuration, the request will complete correctly, and a reply will be returned to the client 190, 200, 210.

In this embodiment, a component of the system 100 responds to packets sent to a physical level multicast address, and sends packets to the address. System components may initialize asynchronously. Once a store 130, 140, 150 has initialized, it multicasts information about its configuration to the multicast address. Typically, all other already-initialized system components receive and process the packet; however, packets may indeed be lost. The configuration protocol addresses this possibility as follows.

A store's configuration packet includes the complete configuration information regarding the store 130, 140, 150. The store 130, 140, 150 continues to multicast the packet unless and until it is instructed by another system to stop. Upon receiving a configuration packet from a store 130, 140, 150, a virtualizer 110, 120 responds to the store 130, 140, 150 with a configuration response packet, containing the complete configuration information about the virtualizer 110, 120, as well as the store 130, 140, 150.

Upon receipt of the configuration response, the store 130, 140, 150 compares its own configuration with that sent to it by the virtualizer 110, 120. If they match, the store 130, 140, 150 stops sending configuration requests; otherwise, the store 130, 140, 150 continues to multicast requests. Immediately after a virtualizer 110, 120 has been initialized, it begins to multicast periodically a configuration request containing its complete configuration information. A virtualizer 110, 120 and/or a store 130, 140 may multicast a configuration reply. Upon receiving a response containing configuration information that matches its own view, the virtualizer 110, 120 stops multicasting. It incorporates the configuration information sent by the replying component, in the virtualizer's configuration database.

In general, a first component (such as a virtualizer 110, 120), once it has been initialized, periodically multicasts a configuration request. A second component (such as a store 130, 140, 150), upon receiving the request, multicasts a reply containing the second component's view of the (complete) system configuration. Upon receiving, from the second component, a configuration response that correctly identifies the configuration of the first component; the first component stops multicasting configuration requests, and incorporates in its configuration view, the configuration multicast by the second component. Typically, a system 100 will comprise multiple components, in which case a third component, a fourth component, and so forth, will multicast a configuration response.

It may be desirable in some cases for the system 100 to export services other than those traditionally associated with NAS stores 130, 140, 150. For example, a store 130, 140, 150 may export a service, and it may be desirable for the virtual store to export this service as well. In a preferred embodiment, the virtualizer 110, 120 may use a port-mapping protocol to query a store 130, 140, 150, to determine the services that are exported by the store 130, 140, 150, and how to access the services. The virtualizer 110, 120 may then export the services as though they were supported by the virtual store 100.

In other cases it may be desirable for the system 100 to maintain a temporary state that should survive online and offline transitions of an individual store 130, 140, 150. For example, a NAS may support a locking protocol so that clients 190, 200, 210 may synchronize access to storage. Locks held by clients 190, 200, 210 ideally should be retained even if the resources to which they refer reside on a store 130, 140, 150 that goes offline.

In other conventional multi-computer systems, a complex protocol is used to maintain a complex state. Conversely, according to the invention, a simple method is used, based on the loose group membership protocol described above. Essentially, temporary state information is multicast on the internal network 160, among “interested” virtualizers 110, 120 as the information changes, or periodically, as the case is necessary. As few packets are multicast, the method is highly scalable, and very simple. In a preferred embodiment, for a relatively slowly changing state, the multicasts may be combined with the group membership multicasts, further improving the efficiency of the method according to the invention.

As mentioned, the invention provides a novel system and method that virtualizes a plurality of network-attached stores 130, 140, 150 working together; i.e., to make the plurality stores 130, 140, 150 appear as if they are one large and highly available store 135. The invention exhibits several advantages over existing virtualization methods. Among these are initial self-configuration, dynamic self-reconfiguration, support for dynamic load balancing, no need for complex cluster protocols, efficient performance tracking, protocol translation flexibility, efficiency via protocol translation, efficiency via MAC address swapping, and efficiency via multicast addressing.

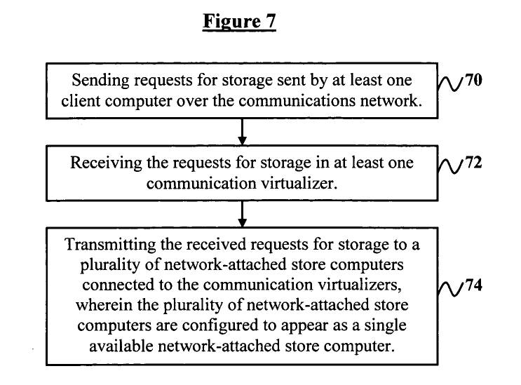

In addition to these features a unique approach that is advantageous is to avoid having to install any software on the client systems. This is critical to customers as clients may number in the thousands and the cost of installing and maintaining software on each system can be prohibitive. The invention achieves this by allowing NFS or CIFS file system access between servers 400 and clients 410 in the form of a communication virtualizer switch 420, which is illustrated in FIG. 6. Moreover, the invention can load balance NFS exported filesystems and CIFS exported filesystems or any network file protocol. Furthermore, the invention can act as a file switch and in fact the software code can be incorporated into a network switch/router but it is not limited to running in a switch/router. Additionally, the invention can operate on the servers it load balances. Also, the invention can operate on general-purpose hardware (e.g., off the shelf computers) or customized hardware. Moreover, the invention has been tested to operate as extension to a general-purpose, embedded and real-time OS. The invention's flexibility in operating on different types of hardware and supporting multiple file protocols give it a decided advantage over the less flexible conventional approaches.

A method of communicating over a communications network is illustrated in the flow diagram of FIG. 7, the method comprises sending 70 requests for storage sent by at least one client computer 190, 200, 210 over the communications network, receiving 72 the requests for storage in at least one communication virtualizer 110, 120, and transmitting 74 the received requests for storage to a plurality of network-attached store computers 130, 140, 150 connected to the communication virtualizers 110, 120, wherein the plurality of network-attached store computers 130, 140, 150 are configured to appear as a single available network-attached store computer 135.

In testing, the invention has shown to analyze and load balances file requests and can do so at either the session or request level. Request level load balancing provides a much richer form of load balancing as any request can be routed to any server. The need for a device with the features provided by the invention, such as an enabler that virtualizes and provide efficient access to multiple file based stores in an autonomic fashion has been a demonstrable advantage in the industry.

Generally, the invention comprises a communications network comprising at least one communication virtualizer, a plurality of network-attached store computers connected to the communication virtualizers, wherein the plurality of network-attached store computers are configured to appear as a single network-attached store computer, and at least one client computer connected to the communication virtualizers. The invention also provides an system for facilitating communication between a client computer 400 and a host computer 410, wherein the system comprises means for sending requests for storage sent by at least one client computer 190, 200, 210 over the communications network, means for receiving the requests for storage in at least one communication virtualizer 110, 120, and means for transmitting the received requests for storage to a plurality of network-attached store computers 130, 140, 150 connected to the communication virtualizers 110, 120, wherein the plurality of network-attached store computers 130, 140, 150 are configured to appear as a single available network-attached store computer 135.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the invention has been described in terms of preferred embodiments, those skilled in the art will recognize that the invention can be practiced with modification within the spirit and scope of the appended claims.

1. A communications network comprising:
at least one communication virtualizer;
a plurality of network-attached store computers connected to said communication virtualizer, wherein said plurality of network-attached store computers are configured to appear as a single available network-attached store computer; and
at least one client computer connected to said communication virtualizer.

2. The communications network of claim 1, further comprising an internal network of connection nodes connecting said communication virtualizer with said network-attached store computers.

3. The communications network of claim 1, further comprising a plurality of external network connections for facilitating a transfer of requests sent by said client computer to said communication virtualizer.

4. The communications network of claim 1, further comprising a plurality of external connection paths for facilitating direct communication between said network-attached store computers and said client computer.

5. The communications network of claim 1, further comprising an Ethernet networking hardware and medium access protocol for facilitating communication within said communication network.

6. The communications network of claim 1, further comprising a Transmission Control Protocol/Internet Protocol suite for facilitating communication between said network-attached store computers and said client computer.

7. The communications network of claim 1, further comprising a storage access protocol for facilitating communication between a storage component within said communications network and remaining components within said communications network.

8. The communications network of claim 7, further comprising a storage access protocol comprises a Network File System protocol.

9. The communications network of claim 7, further comprising a storage access protocol comprises a Common Internet File System protocol.

10. The communications network of claim 1, wherein said communication virtualizer comprises a network router.

11. The communications network of claim 1, further comprising a communication virtualizer file switch connected to a client computer and a server computer for sending requests from said client computer to said network-attached store and from said network-attached store back to said client computer.

12. A method of communication over a communications network, said method comprising:
sending requests for storage originated by at least one client computer over said communications network;
receiving said requests for storage in at least one communication virtualizer; and
transmitting the received requests for storage to a plurality of network-attached store computers connected to said communication virtualizer, wherein said plurality of network-attached store computers are configured to appear as a single network-attached store computer.

13. The method of claim 12, wherein said communication virtualizer, upon receiving requests from said client computer, transmits said request for storage to a chosen network-attached store computer based on a capability of said chosen network-attached store computer to properly process said request for storage.

14. The method of claim 12, wherein said requests for storage are transmitted as a series of packets, each packet comprising a portion of the request for storage, and wherein each packet comprises a packet sequence number.

15. The method of claim 14, wherein said packets comprising a similar request for storage are linked together using a request identifier and said packet sequence number, wherein each request for storage comprises a unique request identifier that is shared among said packets comprising said similar request.

16. The method of claim 12, wherein said network-attached store computer is configured for:
receiving said requests for storage from said communication virtualizer;
processing said request for storage;
creating a corresponding response to said request for storage;
packetizing said corresponding response; and
sending said corresponding response to said communication virtualizer.

17. The method of claim 16, wherein said communication virtualizer is configured for:
receiving said corresponding response from said network-attached store computer;
determining a chosen client computer to which said corresponding response should be routed to; and
routing said corresponding response to a chosen client computer.

18. The method of claim 17, wherein said chosen client computer is configured for:
receiving said corresponding response from said communication virtualizer;
de-packetizing said corresponding response; and
routing said corresponding response to an initiating application.

19. The method of claim 15, wherein said packets are categorized from a zeroth (0th) packet to an ith packet.

20. The method of claim 19, wherein said communication virtualizer determines which network-attached store computer to transmit said request for storage to by examining said zeroth packet in said request.

21. The method of claim 19, further comprising:
said client computer sending standard Ethernet packets to said communication virtualizer; and
said communication virtualizer combining a plurality of standard Ethernet packets comprising a single request for storage into a single standard Ethernet packet.

22. The method of claim 21, further comprising:
said network-attached store computer sending a standard Ethernet packet to said communication virtualizer in reply to a client computer request; and
said communication virtualizer dividing said standard Ethernet packet into a plurality of standard Ethernet packets to send to said client computer as a response comprising multiple standard Ethernet packets.

23. A system for facilitating communication between a client computer and a host computer, said system comprising:
means for sending requests for storage originated by at least one client computer over said communications network;
means for receiving said requests for storage in at least one communication virtualizer; and
means for transmitting the received requests for storage to a plurality of network-attached store computers connected to said communication virtualizer, wherein said plurality of network-attached store computers are configured to appear as a single network-attached store computer.
